(19) United States
(12) Patent Application Publication
(10) Pub. No.: US 2008/0288766 A1
(43) Pub. Date: Nov. 20, 2008

(54) INFORMATION PROCESSING APPARATUS AND METHOD FOR ABORTTING LEGACY EMULATION PROCESS

(75) Inventors: Masayuki Inoue, Kawasaki-shi (JP); Terunobu Hara, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/021,179

(22) Filed: Jan. 28, 2008

(30) Foreign Application Priority Data
May 17, 2007 (JP) 2007131846

(51) Int. Cl. G06F 15/177

(52) U.S. Cl. 713/2

(57) ABSTRACT

An information processing apparatus includes: a non-volatile memory that stores a BIOS program that performs legacy emulation process for enabling a device not supported by an operating system to be accessed from the operating system; a controller that controls the device; a boot process unit that performs a boot sequence for booting the operating system stored in the device by controlling the controller through the legacy emulation process of the BIOS program; and a legacy emulation process control unit that performs a stop control process including: monitoring write access by software to a predetermined register, in which a value for designating an operation environment for controlling the device to the controller is set; and aborting execution of the legacy emulation process by the BIOS program when the write access is detected.

### CROSS-REFERENCE TO RELATED APPLICATIONS

This application is based upon and claims the benefit of priority from Japanese Patent Application No. 2007-131846, filed on May 17, 2007, the entire content of which are incorporated herein by reference.

### BACKGROUND

1. Field

One embodiment of the invention relates to an information processing apparatus, such as a personal computer, that performs a legacy emulation process in accordance with a BIOS program.

2. Description of the Related Art

In recent years, various kinds of portable personal computers, such as a laptop type computer or a notebook type computer, are under development. In these kinds of computers, new interfaces, such as a universal serial bus (USB) interface and an IEEE 1394 interface, are provided. In addition, various kinds of USB devices (USB keyboard, USB memory, USB optical disk drive, USB flexible disk drive, and the like) that can be connected to the USB interfaces have been widely used.

There is disclosed in JP-T-2002-529816 (also published as U.S. Pat. No. 6,567,860 B1) a technique in which an operating system recognizes new hardware or device while the operating system is being installed so that a device driver for controlling the new hardware or device can be automatically installed.

Usually, many BIOS (basic input and output system) programs have a legacy emulation function.

The legacy emulation function is a function for enabling a device such as a USB device, which is not supported by an operating system, to be accessed from the operating system. By using the legacy emulation function of a BIOS, it becomes possible to treat a USB device in the same manner as a known peripheral device even in the case of a system environment where an operating system, which does not support the USB device, is operating, for example.

In addition, the legacy emulation function of the BIOS is also used when booting an operating system stored in USE storage devices, such as a USB memory, a USB optical disk drive, and a USB flexible disk drive. This is because the USB device cannot be accessed until a USB device driver operating on an operating system is loaded even if the operating system is an operating system that supports the USB device.

For this reason, it is necessary to use the legacy emulation function of the BIOS in order to boot an operating system from a USB storage device or load a USB device driver from a USB storage device.

After booting of an operating system that supports a USB device or loading of a USB device driver is executed, control of the USB device is handed over from a BIOS to the operating system or the USB device driver by using the legacy emulation function of the BIOS.

In this handover process, the operating system or the USB device driver needs to execute predetermined procedures for notifying the BIOS of the handover of control of the USB device.

However, in a case of some known software, such as an operating system and a USB device driver, access to a controller for controlling the USB device starts without executing the predetermined procedures described above. In this case, a conflict between access of the BIOS to the controller and access of the software to the controller occurs. As a result, there is a chance that a system operation will be unstable or a system will be hung up.

Accordingly, it is necessary to realize a new function for avoiding the conflict between accesses to the controller.

### SUMMARY

According to a first aspect of the present invention, there is provided an information processing apparatus including: a non-volatile memory that stores a BIOS program that performs legacy emulation process for enabling a device not supported by an operating system to be accessed from the operating system; a controller that controls the device; a boot process unit that performs a boot sequence for booting the operating system stored in the device by controlling the controller through the legacy emulation process of the BIOS program; and a legacy emulation process control unit that performs a stop control process including: monitoring write access by software to a predetermined register, in which a value for designating an operation environment for controlling the device to the controller is set; and aborting execution of the legacy emulation process by the BIOS program when the write access is detected.

According to a second aspect of the present invention, there is provided a method for aborting legacy emulation process executed by a BIOS program for enabling a device not supported by an operating system to be accessed from the operating system, the method including: performing a boot sequence for booting the operating system stored in the device by controlling a controller, which is provided in an information processing apparatus to control the device, through the legacy emulation process of the BIOS program; and performing a stop control process including: monitoring write access by software to a predetermined register, in which a value for designating an operation environment for controlling the device to the controller is set; and aborting execution of the legacy emulation process by the BIOS program when the write access is detected.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view illustrating an external appearance of an information processing apparatus according to an embodiment of the invention, which is viewed from a front side.

FIG. 2 is a block diagram illustrating the system configuration of the information processing apparatus shown in FIG. 1.

FIG. 3 is a block diagram illustrating the functional configuration of a BIOS used in the information processing apparatus shown in FIG. 1.

FIG. 4 is a view illustrating an example of a BIOS setup screen used in the information processing apparatus shown in FIG. 1.

FIG. 5 is a block diagram illustrating an example of USB legacy emulation stop control process executed by the BIOS shown in FIG. 3.

FIG. 6 is a flow chart illustrating an example of procedures of process executed by the BIOS shown in FIG. 3 when the information processing apparatus shown in FIG. 1 is turned on.

FIG. 7 is a flow chart illustrating an example of procedures of USB legacy emulation stop control process executed by the BIOS shown in FIG. 3.

FIG. 8 is a block diagram illustrating an example of the configuration of a USB controller provided in the information processing apparatus shown in FIG. 1.

FIG. 9 is a flow chart illustrating another example of procedures of USB legacy emulation stop control process executed by the BIOS shown in FIG. 3.

### DETAILED DESCRIPTION

An embodiment of the present invention will be described by referring to accompanying drawings.

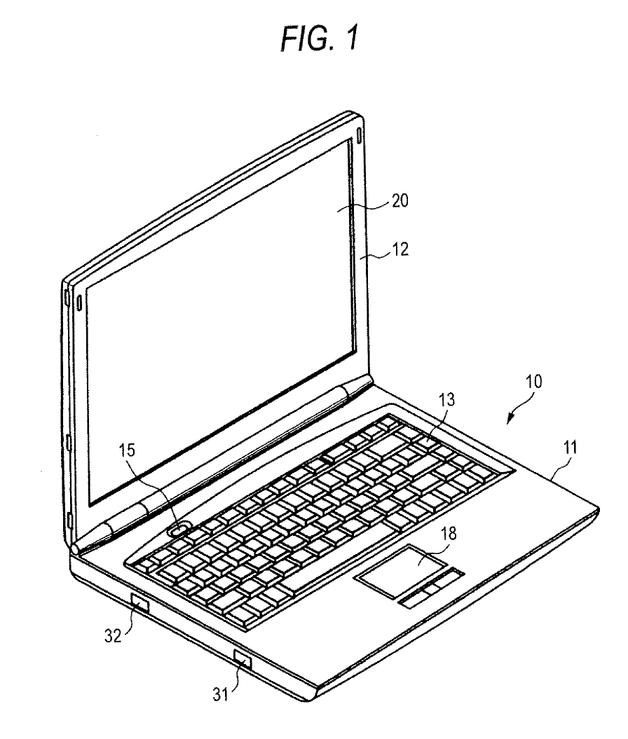

First, the configuration of an information processing apparatus according to an embodiment of the invention will be described with reference to FIG. 1. The information processing apparatus is realized as a portable notebook-type personal computer 10 that can be driven with a battery, for example.

FIG. 1 is a perspective view illustrating the computer 10 in a state in which a display unit is open, which is viewed from a front side. The computer 10 is configured to include a main body 11 and a display unit 12. A display device, such as an LCD (liquid crystal display) 20, is provided in the display unit 12.

The display unit 12 is supported by the main body 11 and is attached so as to be able to freely rotate between an open position, at which a top surface of the main body 11 is exposed, and a closed position, at which the top surface of the main body 11 is closed, with respect to the main body 11. The main body 11 has a thin box shaped housing. A keyboard 13, a power button switch 15 for turning on/off the computer 10, a touch pad is, and the like are provided on the top surface of the main body 11.

Two connection ports 31 and 32 to which various kinds of devices can be connected and from which the devices can be freely disconnected, are provided on a left side surface of the main body 11, for example. Each of the connection ports 31 and 32 is formed using a connector based on universal serial bus (USB) standard, for example. For example, a device (USB device) based on USB standard may be connected to each of the connection ports 31, 32, and 33 as necessary.

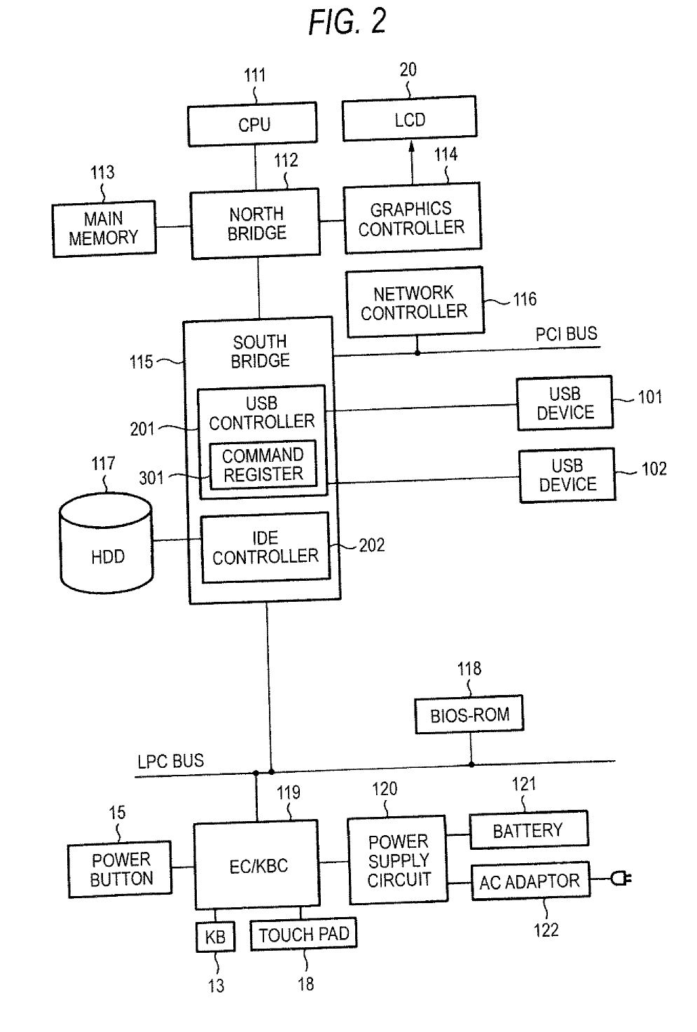

Next, an example of the system configuration of the computer 10 will be described with reference to FIG. 2. The computer 10 includes a CPU 111, a north bridge 112, a main memory 113, a graphics controller 114, a south bridge 115, a network controller 116, a built-in hard disk drive (HDD) 117, a flash BIOS-ROM 118, embedded controller/keyboard controller IC (EC/KBC) 119, and a power supply circuit 120.

The CPU 111 is a processor that controls an operation of each component of the computer 10. This CPU 111 executes an operating system and various kinds of application programs that are loaded from the built-in HDD 117 or an external storage device to the main memory 113.

The CPU 111 also executes a BIOS (basic input output system) program (hereinafter, simply referred to as a ‘BIOS’) stored in the flash BIOS-ROM 118. The BIOS is a program for hardware control. The BIOS has a function of executing legacy emulation process. The legacy emulation function is a function for enabling a device, which is not supported by an operating system, to be accessed from the operating system.

Hereinafter, a case is assumed in which a legacy emulation function supported by a BIOS is a function (USB legacy emulation function) for enabling a USB device based on the USB standard (for example, USB 2.0 standard) to be accessed from an operating system which does not support the USB device. For example, process for emulating procedures for accessing a keyboard based on PS/2 standard, which is executed by an operating system or the like, to procedures for controlling a USB keyboard and process for emulating procedures for accessing a storage device, such as IDE standard, which is executed by the operating system or the like, to procedures for controlling USB storage devices, such as a USB memory, a USB optical disk drive, and a USB flexible disk drive, are executed by the USB legacy emulation function of the BIOS.

The USB legacy emulation function is also used to boot an operating system from a USB storage device. The BIOS executes boot sequences for booting the operating system stored in the USB storage device by using the USB legacy emulation function. Specifically, the BIOS controls a controller for controlling a USB device by using the USB legacy emulation function, thereby accessing the USB storage device so as to boot the operating system from the USB storage device.

The north bridge 112 is a bridge device for establishing a connection between a local bus of the CPU 111 and the south bridge 116. In addition, the north bridge 112 also has a function of executing communication with the graphics controller 114 through an AGP (accelerated graphics port) bus or the like. Moreover, a memory controller that controls the main memory 113 is also built in the north bridge 112. The graphics controller 114 is a display controller that controls an LCD 20 used as a display monitor of the computer 10. The south bridge 115 is connected to a PCI (peripheral component interconnect) bus and an LPC (low pin count) bus. In addition, a USB controller 201 and an ODE (integrated drive electronics) controller 202 for controlling the HDD 117 are provided in the south bridge 115.

The USB controller 201 is a controller that controls devices (USB devices) 101 and 102 connected to the USB ports 31 and 32. The USB controller 201 is configured to control a USB device according to USB 2.0 standard, for example. For example, the USB devices 101 and 102 include a USB keyboard, a USB memory, a USB optical disk drive, and a USB flexible disk drive.

The USB controller 201 includes a command register 301. The command register 301 is a register for setting up the operation environment of the USB controller 201. A value for designating an operation environment for controlling a USB device to the USB controller 201 is set in the command register 301 by a BIOS or other software. The USB controller 201 executes a control of a USB device according to a control method corresponding to a value set in the command register 301. For example, the command register 301 is a register (PCI register) mapped in a PCI configuration space.

The flash BIOS-ROM 118 is a non-volatile memory that stores the above-mentioned BIOS. The embedded controller/keyboard controller IC (EC/KBC) 119 is a one-chip microcomputer in which an embedded controller for power supply management and a keyboard controller which controls the keyboard (KB) 13, the touch pad 18, and the like are integrated.

The embedded controller/keyboard controller IC 119 turns on and off the computer 10 together with the power supply circuit 120, according to a user's operation of the power button switch 15. The power supply circuit 180 generates system power, which is to be supplied to each component of the computer 10, using power from a battery 121 or external power supplied through an AC adaptor 122.

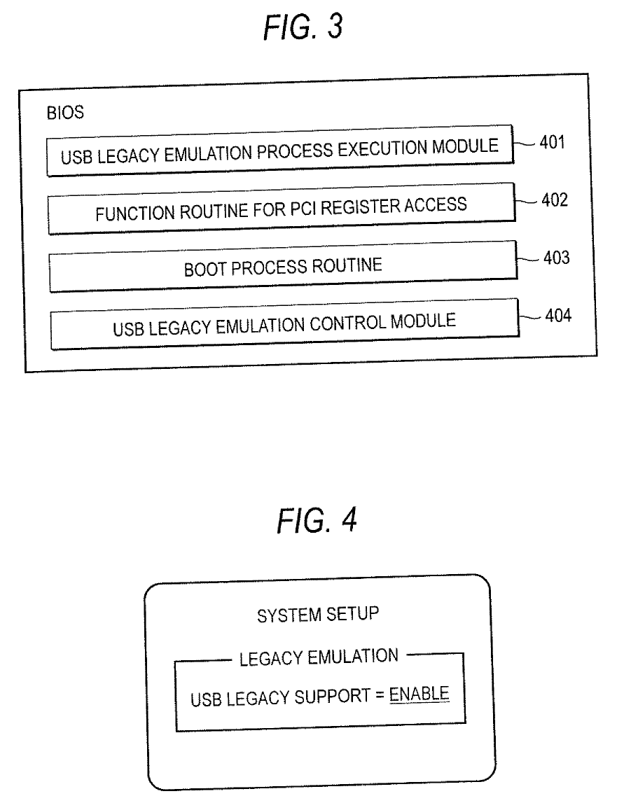

Next, the functional configuration of a BIOS will be described with reference to FIG. 3.

The BIOS includes a USB legacy emulation process execution module 401, a function routine for PCI register access 402, a boot process routine 403, and a USB legacy emulation is control module 404.

The USB legacy emulation process execution module 401 executes the USB legacy emulation process described above. A user may permit or forbid execution of the USB legacy emulation process execution module 401 using a BIOS setup function. An example of a setup screen displayed on the LCD 20 by a BIOS is shown in FIG. 4. The setup screen is a screen for causing a user to designate whether or not to make the USB legacy emulation process effective. A setting item of “USB LEGACY SUPPORT” is displayed on the setup screen. If the user sets ‘USB LEGACY SUPPORT’=ENABLE, execution of the USB legacy emulation process execution module 401 is permitted, the computer 10 is turned on, and then execution of the USB legacy emulation process automatically starts by the BIOS. That is, in the case when the user sets ‘USB LEGACY SUPPORT’=ENABLE, a function for controlling a USB device is included in the BIOS, such that the BIOS can access the USB device.

On the other hand, if the user sets ‘USB LEGACY SUPPORT’=DISABLE, the execution of the USB legacy emulation process execution module 401 is forbidden. In this case, the BIOS does not execute USB legacy emulation process. Accordingly, in the case when the user sets ‘USB LEGACY SUPPORT’=DISABLE, process for booting an operating system from a USB device cannot be executed since the BIOS cannot use the USB device.

The function routine for PCI register access 402 is a routine (INT lAH) for accessing a PCI register. Software called an operating system and a driver program executes access to various kinds of PCI registers using the function routine for PCI register access 402. Since the above command register 301 is also one of the PCI registers, write access of software to the command register 301 is executed through the function routine for PCI register access 402.

The boot process routine 403 executes boot sequences for booting an operating system from various kinds of boot devices. A USB device (USB storage device) connected to the USB port 31 may also be used as the boot device.

For example, in the case when a USB device is designated as a device having a highest boot priority by a user or when an operating system is not stored in boot devices other than the USB device, the boot process routine 403 executes boot sequences for hooting the operating system stored in the USB device (USB storage device) by controlling the USB controller 201 using the USB legacy emulation process execution module 401.

The USB legacy emulation control module 404 executes stop control process for automatically aborting execution of the USB legacy emulation process using the USB legacy emulation process execution module 401. In the stop control process, the USB legacy emulation control module 404 monitors write access of software to the command register 301 within the USB controller 201 and automatically stops execution of the USE legacy emulation process of the USE legacy emulation process execution module 401 when occurrence of the write access is detected.

As described above, an operating system or a USB device driver needs to execute predetermined procedures for notifying the BIOS of handover of control of a USB device before starting access to the USB controller 201. However, in the case of some known software, such as an operating system and a USE device driver, access to the USB controller 201 starts without executing the predetermined procedures described above. In this case, first, corresponding software starts write access to the command register 301 through the function routine for PCI register access 402 in order to set an operation environment of the USB controller 201 to an operation environment based on a USE control method supported by the corresponding software.

The USB legacy emulation control module 404 monitors the write access to the command register 301 performed through the function routine for PCI register access 402 and stops the USB legacy emulation process when occurrence of the write access is detected.

As a result, even in the case that software, which starts a control of a USB device without executing predetermined procedures, is installed in the computer 10 and is executed, occurrence of a conflict between access of a BIOS to the USB controller 201 and access of the software to the USB controller 201 can be prevented beforehand. The user does not need to set ‘USB LEGACY SUPPORT’=DISABLE in order to avoid the conflict. Accordingly, it is possible to boot an operating system from a USB device. In addition, even if a booted operating system or a USB driver operating on the operating system starts a control of the USB controller 201 without executing the predetermined procedures described above, it is possible to prevent occurrence of a system failure due to the conflict between accesses to the controller 201.

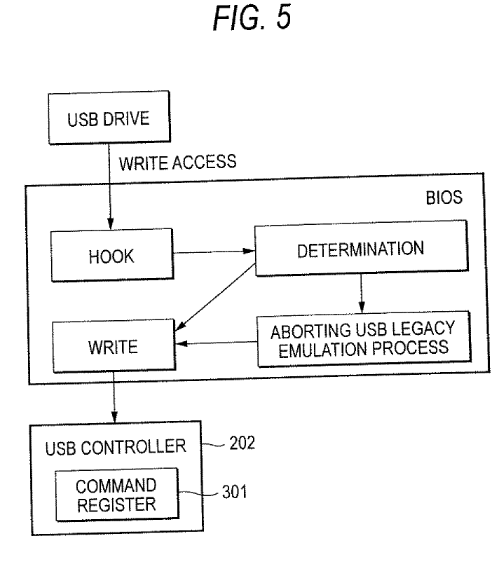

Next, an example of the stop control process executed by the USB legacy emulation control module 404 of the BIOS will be described with reference to FIG. 5.

Software, such as an operating system and a USB driver, starts access to the command register 301 through the function routine for PCI register access 402 in order to set an operation environment of the USB controller 201 to an operation environment based on a USB control method supported by the software.

The BIOS hooks the write access to the command register 301. In addition, the BIOS may hook access to all PCI registers executed through the function routine for PCI register access 402. Moreover, the BIOS determines whether or not a value requested to be written into the command register 301 by the hooked write access is different from a value set beforehand in the command register 301 by the BIOS, that is, whether or not a value requested to be written by write access is a value for changing setting of the operation environment of the USB controller 201. If two hosts whose USB control methods are different, that is, BIOS and software operate at the same time, access of the BIOS to the USB controller 201 and access of the software to the USB controller 201 compete with each other, which causes the USB controller 201 not to normally operate.

Accordingly, if the value requested to be written by write access from the software is a value for changing setting of the operation environment of the USB controller 201, the BIOS immediately stops USB legacy emulation process. Then, the BIOS writes the value, which is requested to be written by write access from the software, in the command register 301. On the other hand, if the value requested to be written by write access from the software is not a value for changing setting of the operation environment of the USB controller 201, the BIOS writes the value, which is requested to be written by the write access from the software, in the command register 301 without aborting the USB legacy emulation process.

Through the process described above, it is possible to prevent a malfunction of the USB controller 201 and to normally hand over control of a USB device to software.

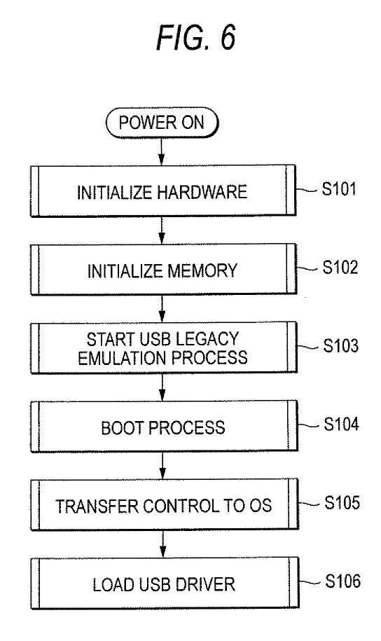

Next, procedures of process executed by a BIOS in response to power ON of the computer 10 will be described with reference to a flow chart shown in FIG. 6. Here, a case in which an operating system stored in the USB device 101 is booted is assumed.

If the computer 10 is turned on, a BIOS is first executed by the CPU 111. First, the BIOS initializes hardware (chip set including a north bridge and a south bridge, network controller, and the like) (step S101). Subsequently, the BIOS initializes the main memory 113 (step S102).

Then, the BIOS executes the USB legacy emulation process execution module 401 to start USB legacy emulation process (step S103). Then, the BIOS boots an operating system stored in the USB device 101 by controlling the USB controller 201 through the USB legacy emulation process (step S104).

In step S104, for example, the boot process routine 403 in the BIOS issues to the USB legacy emulation process execution module 401 a disk access request for designating a drive number, which is assigned to the USB device 101 by the USB legacy emulation process. The USB legacy emulation process execution module 401 emulates procedures for accessing an existing storage device such as a hard disk drive, which is executed by the boot process routine 403, to procedures for accessing the USB device 101 through the USB controller 201. Thus, the boot process routine 403 in the BIOS can boot the operating system from the USB device 101. In the boot process, the boot process routine 403 loads a boot loader of the operating system, which is stored in a master boot record (MBR) of the USB device 101, to the main memory 113. Then, when the boot loader of the operating system is executed by the CPU 111, a control is handed over from the BIOS to the operating system (step S106).

Thereafter, the USB legacy emulation process execution module 401 loads the USB device driver stored in the USB device 101 to the main memory 113 under the control of the boot loader of the operating system (Step S106).

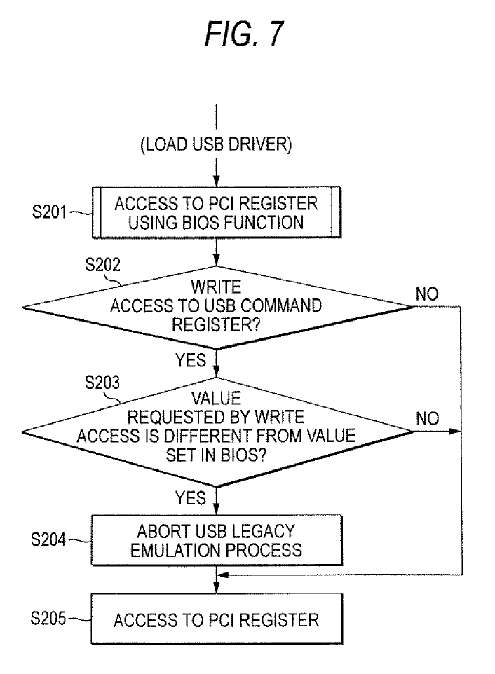

Next, an example of procedures of USB legacy emulation stop control process executed by the USB legacy emulation control module 404 of the BIOS will be described with reference to a flow chart shown in FIG. 7.

When a USB device driver is loaded, the USB device driver starts write access to the command register 301 of the USB controller 201 in order to perform initial setting of the USE controller 201. The write access to the command register 301 is executed through the function routine for PCI register access 402 of the BIOS, in the same manner as access to other PCI registers.

The BIOS monitors access of various kinds of software to the PCI register, which is executed through the function routine for PCI register access 402. As described above, this monitoring is executed using the USB legacy emulation control module 404.

When the software issues a request of write access to the PCI register to the function routine for PCI register access 402 (BIOS call of INT lAH), the BIOS determines whether or not the write access request is a request of write access to the command register 301 (step S202).

If the write access request corresponds to the write access to the command register 301 (YES in step S202), the BIOS determines whether or not a value requested to be written by the write access request from the software is different from a value set beforehand in the command register 301 by the BIOS (step S203).

If the value requested to be written by the write access request from the software is different from the value set beforehand in the command register 301 by the BIOS (YES in step S203), the BIOS stops execution of the USB legacy emulation process (step S204). After aborting the execution of the USB legacy emulation process, the BIOS writes the value, which is requested to be written by the write access from the software, in the command register 301 (step S205).

If the write access request from the software is not write access to the command register 301 (NO in step S202), the BIOS writes the value, which is requested to be written by the write access from the software, in a PCI register designated by the write access request without aborting execution of the USB legacy emulation process (step S205).

If the value requested to be written by the request of write access to the command register 301 is equal to the value set beforehand in the command register 301 by the BIOS (NO in step S203), the BIOS writes the value, which is requested to be written by the write access request from the software, in the command register 301 without aborting the execution of the USB legacy emulation process (step S205).

For example, process in step S203 may be omitted. In this case, if the write access request is write access to the command register 301 (YES in step S202), the BIOS sequentially executes process in steps S204 and S205.

The BIOS may also monitor the write access of the software to the command register 301 by using an interrupt signal from the USB controller 201.

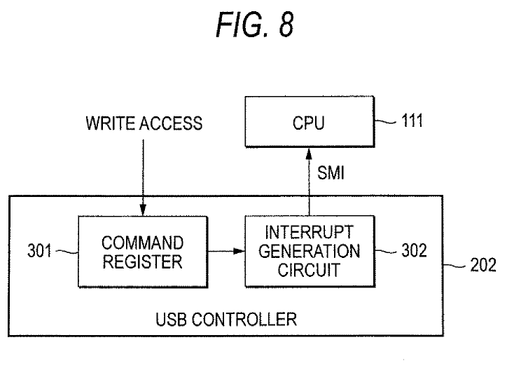

In FIG. 8, an example of the configuration of the USB controller 201 having an interrupt generating function is shown.

The USB controller 201 includes an interrupt generating circuit 302. The interrupt generating circuit 302 generates an interrupt signal in response to the write access to the command register 301, that is, when a value existing in the command register 301 is written. The interrupt signal is transmitted to the CPU 111, as an interrupt signal such as a system management interrupt (SMI) signal, through an interrupt controller provided within the south bridge 115, for example. When the interrupt signal SMI is input to the CPU 111, the BIOS (for example, SMBIOS) is executed.

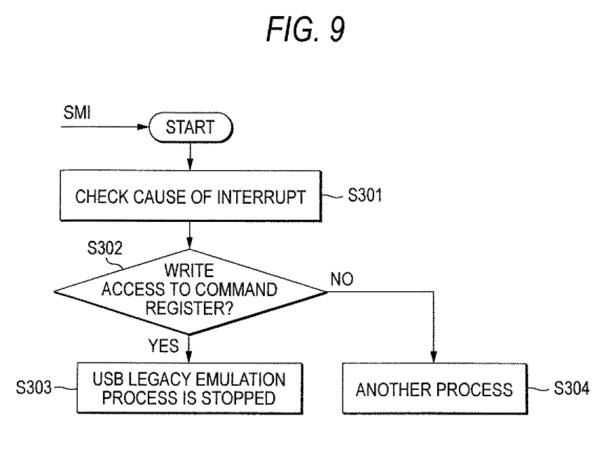

Next, an example of procedures of USB legacy emulation stop control process executed by the BIOS will be described with reference to a flow chart shown in FIG. 9.

When the interrupt signal SMI is input to the CPU 111, the BIOS is executed. First, the BIOS checks what made the interrupt signal SMI generated (cause of interrupt) by referring to a status register of the interrupt controller, for example (step S301). If the interrupt has occurred due to write access to the command register 301 of the USB controller 201 (step S302), the BIOS stops execution of the USB legacy emulation process (step S303). On the other hand, if the cause of interrupt is not the write access to the command register 301 of the USB controller 201, the BIOS executes process corresponding to the cause (step S304).

As described above, in the present embodiment, even in the case that software, which starts a control of a USE device without executing predetermined procedures, is installed in the computer 10 and is executed, occurrence of the conflict between access of the BIOS to the USB controller 201 and access of the software to the USB controller 201 can be prevented beforehand. Thus, by providing a function for avoiding the conflict in the BIOS, it is possible to prevent occurrence of a malfunction even if a known USB driver that starts the control of a USB device without executing predetermined procedures is used.

Furthermore, the explanation has been made using the USB device as an example in the present embodiment. However, the invention is not limited to the USB device. For example, the invention may also be applied to an IEEE 1394 in the same manner.

The present invention is not limited to the embodiment described above, but the invention may be embodied in practice by modifying constituent components without departing the scope of the claimed invention. Various kinds of inventions may be realized by proper combination of the plurality of constituent components disclosed in the embodiment described above. For example, some constituent components may be eliminated from all the components shown in the above embodiments. Moreover, constituent components in different embodiments may be appropriately combined.

What is claimed is:

1. An information processing apparatus comprising:
a non-volatile memory that stores a BIOS program that performs legacy emulation process for enabling a device not supported by an operating system to be accessed from the operating system;
a controller that controls the device;
a boot process unit that performs a boot sequence for booting the operating system stored in the device by controlling the controller through the legacy emulation process of the BIOS program; and
a legacy emulation process control unit that performs a stop control process including:
monitoring write access by software to a predetermined register, in which a value for designating an operation environment for controlling the device to the controller is set; and
aborting execution of the legacy emulation process by the BIOS program when the write access is detected.

2. The apparatus according to claim 1, wherein the write access by the software to the register is executed through a function routine provided within the BIOS program, and
wherein the legacy emulation process control unit performs the stop control process further including:
hooking the write access by the software to the predetermined register executed through the function routine;
determining whether or not a value requested to be written into the register by the hooked write access is a value for changing setting of the operation environment of the controller; and
aborting execution of the legacy emulation process by the BIOS program when the value requested to be written is the value for changing setting of the operation environment of the controller.

3. The apparatus according to claim 2, wherein the legacy emulation process control unit performs writing the value requested to be written in the register after aborting the execution of the legacy emulation process by the BIOS program.

4. The apparatus according to claim 1, wherein the device is a universal serial bus (USB) device.

5. The apparatus according to claim 1, wherein the controller outputs an interrupt signal in response to the write access to the register, and
wherein the legacy emulation process control unit detects that the write access by the software to the register occurred when the interrupt signal is output from the controller.

6. A method for aborting legacy emulation process executed by a BIOS program for enabling a device not supported by an operating system to be accessed from the operating system, the method comprising:
performing a boot sequence for booting the operating system stored in the device by controlling a controller, which is provided in an information processing apparatus to control the device, through the legacy emulation process of the BIOS program; and
performing a stop control process including:
monitoring write access by software to a predetermined register, in which a value for designating an operation environment for controlling the device to the controller is set; and
aborting execution of the legacy emulation process by the BIOS program when the write access is detected.

7. The method according to claim 6, wherein the write access by the software to the register is executed through a function routine provided within the BIOS program, and
wherein the stop control process further includes:
hooking the write access by the software to the predetermined register executed through the function routine;
determining whether or not a value requested to be written into the register by the hooked write access is a value for changing setting of the operation environment of the controller; and
aborting execution of the legacy emulation process by the BIOS program when the value requested to be written is the value for changing setting of the operation environment of the controller.

8. The method according to claim 7, wherein the stop controlling process further includes writing the value requested to be written in the register after aborting the execution of the legacy emulation process by the BIOS program.

9. The method according to claim 6, wherein the device is a universal serial bus (USB) device.

10. The method according to claim 6, wherein the controller is configured to output an interrupt signal in response to the write access to the register, and
wherein the legacy emulation process includes detecting that the write access by the software to the register occurred when the interrupt signal is output from the controller.
